(19) United States
(12) Patent Application Publication
(10) Pub. No.: US 2018/0153220 A1
(43) Pub. Date: Jun. 7, 2018

(54) VAPORIZER WITH CARTRIDGE

(71) Applicant: VMR Products LLC, Miami, FL (US)

(72) Inventors: Jan Andries VERLEUR, Miami Beach, FL (US); Dan RECIO, Miami Beach, FL (US); Zhiyuan LIU, Miami, FL (US); Hans VERLEUR, El Dorado, CA (US)

(73) Assignee: VMR Products LLC, Miami, FL (US)

(21) Appl. No.: 15/829,490

(22) Filed: Dec. 1, 2017

Related U.S. Application Data
(60) Provisional application No. 62/429,371, filed on Dec. 2, 2016.
(60) Provisional application No. 62/468,143, filed on Mar. 7, 2017.

(51) Int. Cl. A24F 47/00; H05B 3/46

(52) U.S. Cl. CPC A24F 47/008; H05B 3/46

(57) ABSTRACT

A vaporizer unit having a cartridge and a battery unit is disclosed. The cartridge has a replaceable heating unit and a U shaped flow path. The battery unit is removably coupled to the cartridge and has indicator lights that illuminate through a body of the battery unit.

### CROSS REFERENCE TO RELATED APPLICATIONS

This application claims the benefit of U.S. Provisional Application Ser. No. 62/429,371, filed Dec. 2, 2016 and U.S. Provisional Application Ser. No. 62/468,143, filed Mar. 7, 2017, the disclosures of each of which are hereby incorporated herein by reference in their entireties.

### BACKGROUND

### 1. Technical Field

This disclosure relates generally to vaporizers, and more particularly to a cartridge for a vaporizer.

### 2. Background Information

Vaporizers have recently emerged as a new product for providing nicotine and other products through a smokeless inhalation process. There are many embodiments of vaporizers including the electronic cigarette. In general, implementations consist of a power supply (typically a battery) and an atomizing device. In reusable electronic cigarettes, the two items are separated into a battery and a cartomizer, to allow the disposal and replacement of the nicotine containing fluid cartomizer while preserving for additional use the more costly battery and associated circuitry (microcontroller, switch, indicating light emitting diode (LED), etc.). In disposable electronic cigarettes the two functions are integrated into one unit that is disposed of after exhaustion of either the battery energy or the vaporizable fluid (“E-liquid”), typically nicotine-containing, that is associated with the cartomizer.

The E-liquid that is used to produce vapor in electronic cigarettes is typically a flavor concentrate, optionally with a variable percentage of a liquid nicotine concentrate, dissolved in a solution of one or more of propylene glycol (PG) and/or vegetable glycerin (VG) and/or polyethylene glycol 400 (PEG400). This liquid is often sold in a bottle or in disposable cartridges or cartomizers. Many different flavors of such E-liquids are sold, including flavors that resemble the taste of regular tobacco, menthol, vanilla, coffee, cola and various fruits. E-liquids containing a wide range of nicotine concentrations, as well as nicotine-free liquids are available in the marketplace.

Known vaporizers typically contain a single straight air channel, with air flowing into the bottom of the vaporizer, mixing with vapor, and then exiting through the top of the vaporizer. This structural configuration contributes to E-liquid condensation in the device, and in some instances, causes overflowing E-liquid to overflow in the device and/or leak out of the device's bottom air intake. Accordingly, users of known commercial vaporizer devices have experienced problems with, inter cilia, the leakage of E-liquid from the cartomizer in use and/or under storage conditions, especially after use. Such leakage is undesirable for at least the reasons of cost and/or inadvertent contamination of person or personal effects, ultimately adversely affecting a user's opinion of the overall experience associated with using the device. Certain embodiments described in the present disclosure are directed to the reducing, inhibiting, and/or eliminating such leakage from the user's experience, as well as other important ends, which will become apparent to the reader once armed with the disclosures provided herein.

### BRIEF SUMMARY

In one aspect, embodiments are directed to a vaporizer having a body and a cartridge, typically referred to as a cartomizer. In use, the cartomizer portion of the vaporizer is proximate to the user and the body is distal to the user. The body houses a battery and a control panel. The body has a proximate end defining a chamber for receiving a distal end of the cartridge. The cartridge's distal end is sized and shaped to complement the shape of the chamber defined by the body's proximate end. The cartridge is configured to house a vaporizable product and includes an air intake at a middle portion or proximate end of the cartridge, a heating unit proximate to the distal end of the cartridge, and a vapor outlet proximate to the distal end of the cartridge. In embodiments where the vaporizer is designed for use with E-liquids, a fluid connection exists between the heating unit and a cavity or container within the cartridge used to store the E-liquid prior to use.

In another aspect, embodiments are directed to a cartridge for a vaporizer. The cartridge includes a cartridge body having a base, an air intake, a mouthpiece, a cavity, a printed circuit board (PCB) and a replaceable heater. The air intake is proximate to a middle portion or proximate end of the cartridge body and provides a fluid passage into the cartridge body and further into the replaceable heater. The replaceable heater is disposed within the base of the cartridge body and is fluidly connected to the intake and the mouthpiece. The mouthpiece is located at the proximate end of the cartridge body and provides a fluid passage from the replaceable heater through the mouthpiece to the user or external environment. Thus, there is fluid connectivity from an external environment through the intake, into and out from the replaceable heater through the mouthpiece to an external environment and/or to the user. The cavity is configured to store a product for vaporizing and is fluidly connected to the replaceable heater.

In another aspect, embodiments are directed to a battery case for a vaporizer. The battery case includes a body, a battery disposed in the battery case body, at least one light source within the body, and circuitry disposed within the body, configured to operate the vaporizer and at the least one light source within the body. The body has at least one pattern of micro holes positioned over at least one of the at least one light source(s), with the micro holes independently having a diameter less than fifty micrometers.

### BRIEF DESCRIPTION OF THE DRAWINGS

FIG. 1 illustrates an embodiment of a cartridge for a vaporizer.

FIG. 2 a cross section of the cartridge of FIG. 1 taken at line AA.

FIG. 3 illustrates a partially exploded view of a cartridge showing a replaceable heater.

FIG. 4 illustrates a cross section of a vaporizer having a cartridge and battery unit.

FIG. 5 illustrates a vaporizer having a cartridge and battery unit.

FIG. 6 a base of a battery unit showing a ring LED.

FIG. 7 illustrates a vaporizer having a cartridge and battery unit.

FIG. 8 illustrates a cylindrical body being orientated for a drilling process.

FIG. 9 illustrates a cylindrical body being orientated for a drilling process.

### DETAILED DESCRIPTION

The following detailed description and the appended drawings describe and illustrate some embodiments of the disclosure for the purpose of enabling one of ordinary skill in the relevant art to make and use these embodiments. As such, the detailed description and illustrations of these embodiments are purely illustrative in nature and are in no way intended to limit the scope of the disclosure in any manner. It should also be understood that the drawings are not necessarily to scale and, in certain instances, details may have been omitted, which are not necessary for an understanding of the embodiments, such as details of fabrication and assembly. In the accompanying drawings, like numerals represent like components.

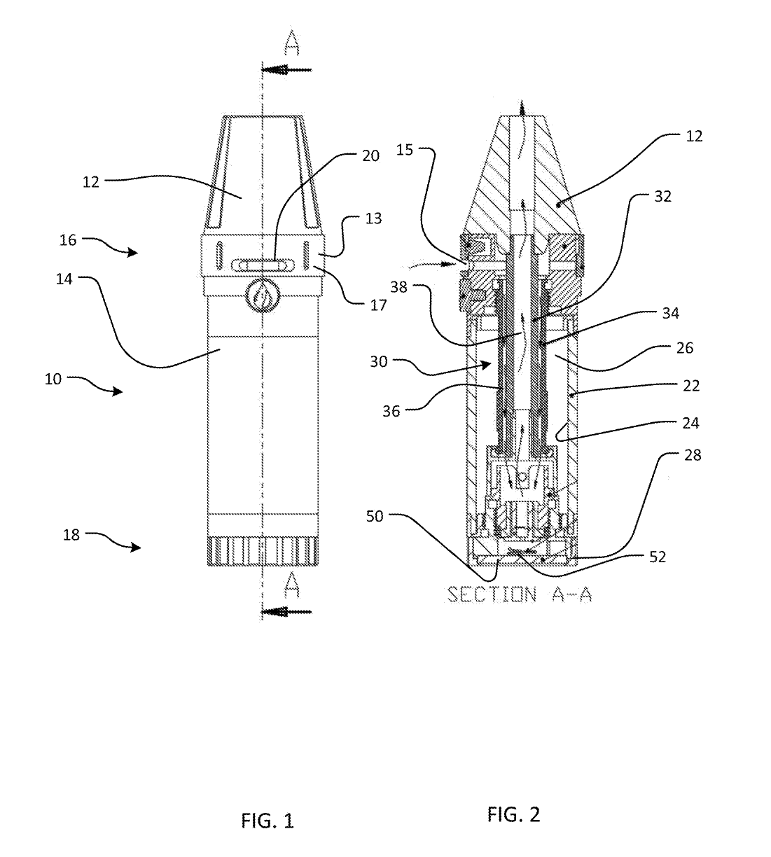

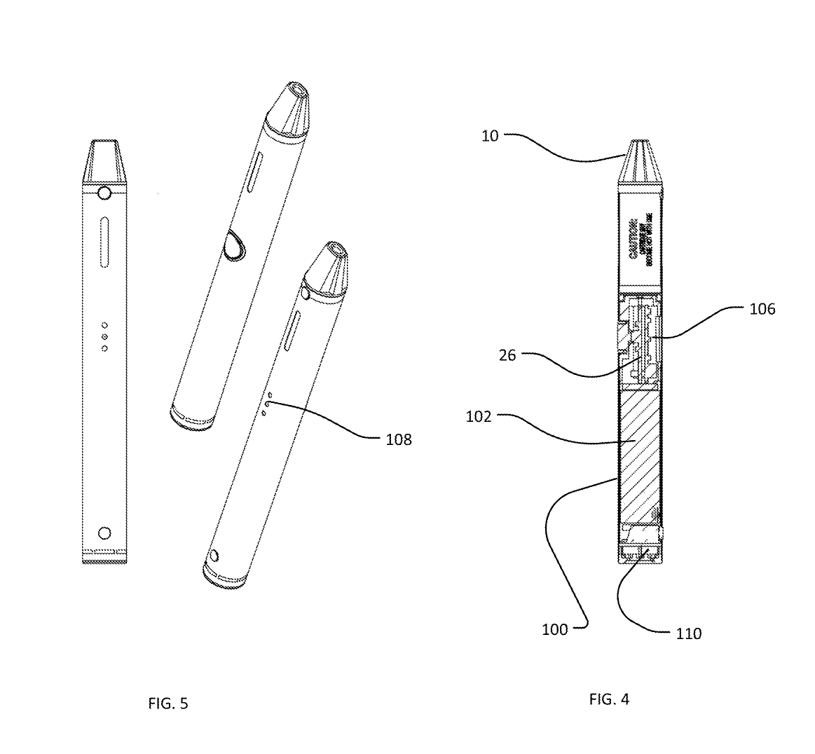

FIG. 1 illustrates an embodiment of a cartridge 10 for a vaporizer. Cartridge 10 includes a mouthpiece 12, adjustable flow control portion 13, and a cartridge body 14. Adjustable flow control portion 13 is secured to an upper end 16 of body 14 using conventional techniques such a threaded connection or a press fit. Mouthpiece 12 is connected to the adjustable flow control portion 13 using conventional techniques. A distal end 18 of body 14 is configured to attach to a power unit such as the battery unit shown in FIG. 4. Body 14 may be coupled to the power unit through common techniques such as threads, magnets, and/or pins.

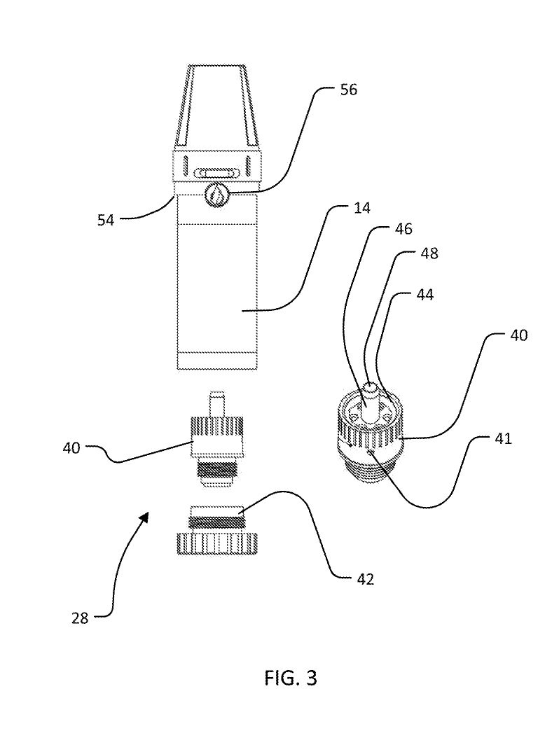

Body 14 has an outer wall 22 with an inner surface 24 partially defining an internal chamber. A base assembly 28 coupled to the distal end of the body 14 includes a heating unit 40 (FIG. 3) for vaporizing E-liquid. The base assembly 28 further supports an inner column 30 having an outer liner 34 and an inner liner 32. An outer surface of the outer liner 34 together with outer wall 22 defines, at least in part, a tank 26 within an internal chamber of body 14 that stores E-liquid. An intake passageway 36 is formed between an inner surface of the outer liner 34 and an outer surface of the inner liner 32 and an exhaust passageway 38 is formed by a through hole extending along the main axis of inner liner 32.

Adjustable flow control portion 13 has an inlet 15 through which air enters the cartridge 10. Inlet 15 is in fluid communication with intake passageway 36. An airflow ring 17 is configured to rotate about the adjustable flow control portion 13 to adjust the restriction of airflow into the intake passageway 36. Airflow ring 17 has a slot 20 that is sized similarly to inlet 15. Minimum airflow restriction is achieved when the slot aligns with inlet 15. Inlet 15 may be completely obstructed by rotating airflow ring 17 until no portion of the slot aligns with the inlet 15. Adjustable flow control portion 13 may include a spring ball beneath airflow ring 17 that interfaces with indentations in the airflow ring 17. The interaction of the indentations and the spring ball allows for indexed positioning when rotating airflow ring 17. As the air flow ring is rotated in moving from one indexed position to another, the spring ball compresses the spring configured thereto, and maintains this compression until the ball comes into contact with a second indentation. At this point the spring provides force to recess the ball into the indentation, thereby aligning to a slot or hole(s) having a second flow rate.

FIG. 3 illustrates an exploded view of base assembly 28 of the embodiment of FIG. 1, removed from body 14 for clarity. Base assembly 28 has a heating unit 40 and a threaded base 42. Heating unit 40 has a recess 44 with a lip for receiving outer liner 34. (See also FIG. 2). A seal within the recess 44 seals outer liner 34 to heating unit 40. (See also FIG. 2). The lip on outer liner 34 is press fit within the recess 44 and engages the lip of recess 44 to secure outer liner 34 in place. Heating unit 40 has a protrusion 46 within recess 44 that provides a mating surface for the inner surface of inner liner 32 with the heating unit. A bore 48 within heating unit 40 provides a fluid passage from base assembly 28 to exhaust passageway 38. Heating unit 40 includes port 41 for receiving E-liquid from tank 26. The received E-liquid is vaporized within heating unit 40 and thereafter mixes with a flow of air from intake passageway 36 and is exhausted through exhaust passageway 38.

Threaded base 42 has an external thread 43 that threads into the distal end 18 of body 14 to secure the base assembly 28 to the body 14. Threaded base 42 has an internal thread that complements an external thread 45 of heating unit 40. Heating unit 40 is secured to threaded base 42, which is in turn secured to the body 14, thereby holding the heating unit 40 within body 14. A printed circuit board 50 (FIG. 3) has an electrical contact spring 52, for making electrical contact to a pin of heating unit 40. (See also FIG. 2). Heating unit 40 is replaceable by, for example, unthreading threaded base 42 and replacing heating unit 40.

Cartridge 10 may be assembled as follows. Heating unit 40 screws onto threaded base 42 to form base assembly 28. An electrical contact at the base of heating unit 40 contacts spring 52 to make an electrical connection when heating unit 40 and threaded base 42 are joined. Body 14 is inverted with the base end facing upwards. Tank 26 is filled with E-liquid and base assembly 28 is screwed onto the threads of body 40 to seal tank 26. A dual channel airflow is formed with the intake passageway 36 and the exhaust passageway 38 when base assembly 28 is connected to body 14. Cartridge 10 can then be connected to a battery unit for power.

In some embodiments, a battery unit may have an upper recess sized and shaped to receive body 14. A shank of body 14 may be inserted into the battery unit up to shoulder 54. Orientation key 56 may orient the cartridge 10 within the battery unit and may be spring loaded to hold the cartridge 10 in place.

In operation, a user activates the heating unit 40 causing E-liquid to vaporize. The user draws air through the dual channel airflow passageway formed in the device by exerting negative pressure at mouthpiece 12. This air is mixed with the vapor as it passes through the heater's headspace. The airflow to the heating unit may be adjusted by rotating air flow ring 17, to vary and/or regulate the flow desired and/or pressure necessary to draw a desired amount of air/vapor mixture toward the user.

FIG. 4 illustrates a cross section of an embodiment of a cartridge 10 combined with a battery unit 100. As described previously, battery unit 100 has a recess at the upper end that is sized and shaped to receive a vaporizer cartridge. While the battery unit 100 will be described in relation to the cartridge 10 of FIG. 1, it will be understood that other types of cartridges may be used with the battery unit 100. The electronic controls for the cartridge are contained within the battery unit 100, such that the cartridge's only necessary electrical connection to the battery unit 100 is power for a heating unit. The battery unit 100 supplies the heating unit with a variable voltage and variable temperature control.

Battery unit 100 includes a battery 102 and a printed circuit board 104. The circuit board 104 incorporates an integrated circuit control and booster chip with transistor for the variable voltage/temperature functionality. There are three LEDs 106 on the printed circuit board 104 that are visible through holes 108 in the battery case 100. FIG. 5 illustrates the cartridge 10 combined with the battery unit 100 and shows the holes 108. The LEDs may serve multiple functions. In the embodiment of FIG. 5, the LEDs serve as an indicator of the temperature or of the voltage setting. For example, a single LED may be lit for low power, two LEDs may be lit for medium power, and three LEDs may be lit for high power. In addition, the LEDs may have a variable color for further indication of information. In addition to the LEDs on the printed circuit board 104, there are multiple LEDs on a lower circuit board 110 at the bottom of the battery unit 100. The LEDs on the lower circuit board 110 communicate different information depending on a mode of the battery unit 100. In a first, stealth mode, all of the lights may be turned off on the battery unit. In a second, activation mode, the LEDS, may all be lit. In a third mode, battery indication mode, the number of LEDs lit may convey the state of charge of battery 102. The LEDs may indicate the mode they are in by way of color, or other characteristic.

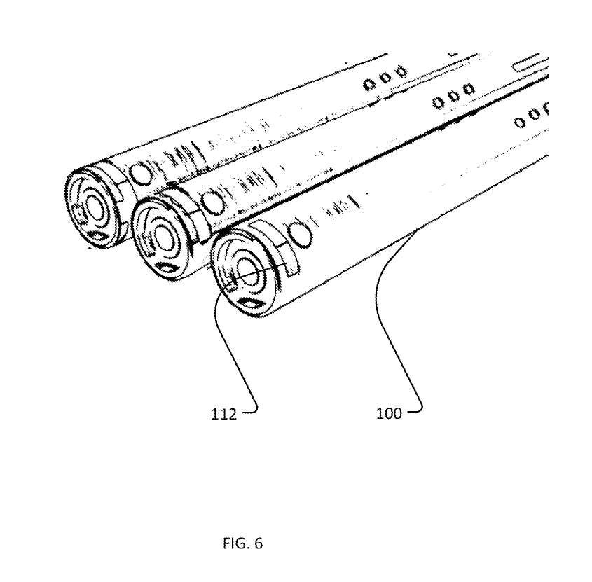

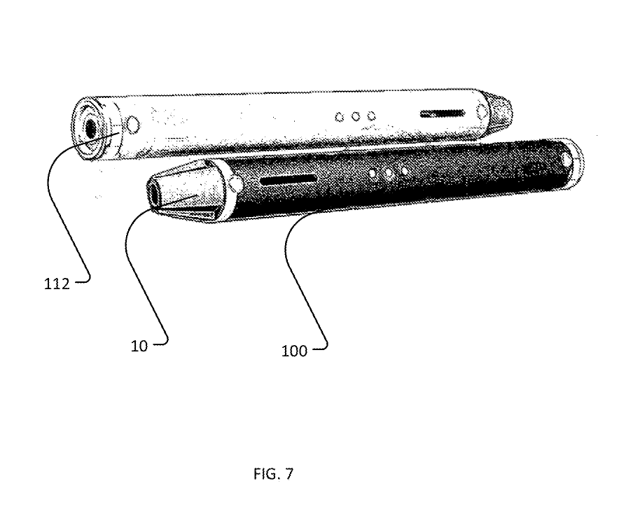

FIG. 6 illustrates a lower end of the battery unit 100, highlighting a ring pattern 112 at a base of the battery unit 100. FIG. 7 illustrate a cartridge 10 combined with a battery unit 100. In some embodiments, the LED indicators align with a pattern of micro drilled holes in the battery unit 100. The micro drilled holes are extremely small in diameter, such that the holes are not noticeable unless the underlying LED is illuminated. The LEDs on the lower circuit board 110 may align with the ring pattern 112 segmented into multiple sections. The LEDs may light independently to give visual feedback to the user about the unit.

Micro drilling has not been used previously with E-cigarettes for various reasons. The end of a micro drill has a cutting edge (called the chisel edge) made by two intersecting planes which also define the two primary cutting edges of the drill. The chisel edge removes material primarily by extrusion and cutting at high negative rake angle. The chisel edge adds to the drilling complexity because of the lack of a point. As the rotating drill first contacts the work piece anything on the surface, including microroughness and material slope, will cause the drill to walk on the surface as it is trying to begin removing material. When working on a cylindrical component, such as the rounded surface of a battery case, walking of the micro drill bit makes drilling nearly impossible. Walking is characterized by an eccentric motion of the drill as it turns perhaps coupled with a non-time-varying bending of the drill about its longitudinal axis. Depending on the feed per revolution of the drill during hole start-up, the drill may begin drilling at a slant with the drill deflected like an end-loaded cantilever beam. If permitted to continue, the drill will quickly break. If the drill is strong enough to survive the large stress imposed in it due to drilling at a slant, the resulting hole will be slanted rather than normal to the work surface.

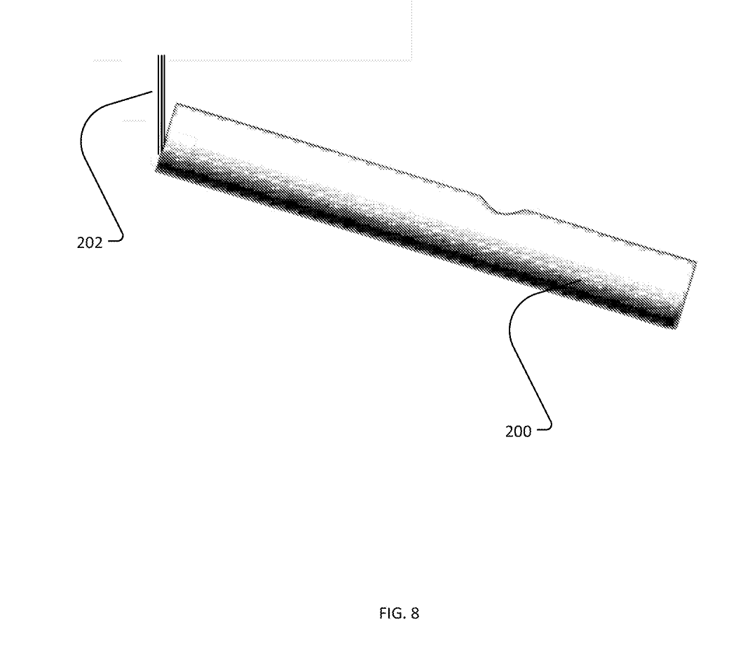

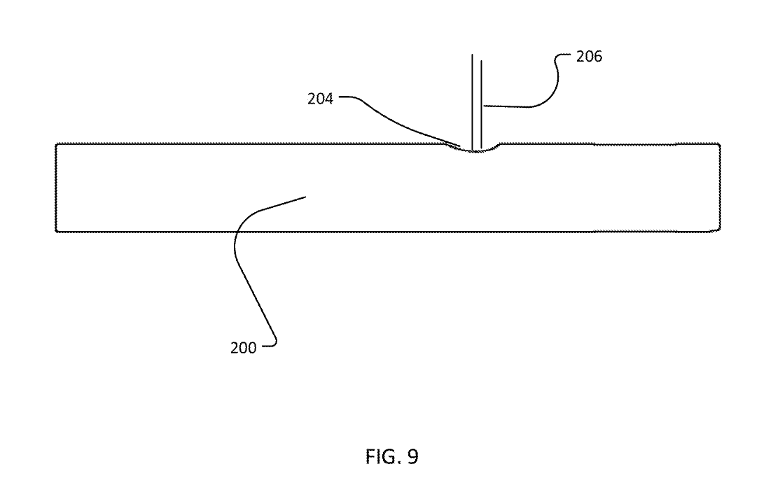

FIG. 8 illustrates a technique for micro drilling a hollow cylindrical body 200. As described previous, micro drilling is nearly impossible on the outer surface of the cylindrical body 200. The cylindrical body of FIG. 8 is tilted, exposing an inner surface of the cylindrical body 200 to a vertical drill path 202. Because the drill encounters a concave surface, walking is minimized. Micro drilling in this way allows for a pattern of holes with a diameter less than fifty micrometers to be drilled through the surface of the cylindrical body 200. For example, each of the holes in the pattern of holes may have a respective diameter less than fifty micrometers. A light source, such as an LED, may shine through the micro drilled holes to illuminate the pattern, even though the micro drilled holes themselves may not be noticeable when no light is shining through them.

FIG. 9 illustrates a technique for micro drilling in another area of the cylindrical body 200. Cylindrical body 200 has a hole 204 cut out in it for another component, such as a button or liquid crystal display. This hole 204 may be used as an access point for micro drilling on the inner surface of the cylindrical body 200 opposing the hole 204. The micro drill may access the hole in a direction general perpendicular to the length of the cylindrical body as shown by lines 206.

The descriptions set forth above are meant to be illustrative and not limiting. Various modifications of the embodiments, in addition to those described herein, will be apparent to those skilled in the art from the foregoing description. Such modifications are also intended to fall within the scope of the concepts described herein. Each patent, patent application and publication cited or described in this document are hereby incorporated herein by reference, in their entireties.

The foregoing description of possible implementations consistent with the present disclosure does not represent a comprehensive list of all such implementations or all variations of the implementations described. The description of some implementation should not be construed as an intent to exclude other implementations. For example, artisans will understand how to implement the embodiments in many other ways, using equivalents and alternatives that do not depart from the scope of the disclosure. Moreover, unless indicated to the contrary in the preceding description, none of the components described in the implementations are essential to the embodiments disclosed. It is thus intended that the embodiments be considered as illustrative, with a true scope and spirit of the disclosure being indicated by the following claims.

The invention illustratively disclosed herein suitably may be practiced in the absence of any element which is not specifically disclosed herein. The invention illustratively disclosed herein suitably may also be practiced in the absence of any element which is not specifically disclosed herein and that does not materially affect the basic and novel characteristics of the claimed invention.

1. A vaporizer comprising:
a body, the body including a battery and a control panel, wherein the body has an upper end with a chamber; and
a cartridge sized and shaped to complement the chamber, the cartridge having a vaporizable product tank, a fluid intake at an upper end of the cartridge, a heating unit at a lower end of the cartridge, and a fluid outlet at an upper end of the cartridge.

2. The vaporizer of claim I, wherein the cartridge defines a continuous fluid path that extends from the fluid intake to the heating unit and from the heating unit to the fluid outlet.

3. The vaporizer of claim I, wherein the cartridge further comprises an inner column defining:
an intake passageway fluidly connecting the fluid intake with the heating unit; and
an exhaust passageway fluidly connecting the heating unit with the fluid outlet.

4. The vaporizer of claim 3, wherein:
the inner column comprises an inner liner and an outer liner surrounding the inner liner; and
the intake passageway is formed between the outer liner and the inner liner.

5. The vaporizer of claim 4, wherein the exhaust passageway is defined within the inner liner.

6. The vaporizer of claim 3, wherein:
the cartridge further comprises an outer wall surrounding the inner column; and
the vaporizable product tank is formed between the outer wall and the inner column.

7. The vaporizer of claim 6, wherein the heating unit defines at least one port in fluid communication with the vaporizable product tank.

8. A cartridge for a vaporizer, comprising:
a body having an upper end and a base;
a replaceable heater within the base of the body;
a fluid intake proximate the upper end of the body, the intake providing a fluid path into the body and to the replaceable heater;
a mouthpiece at an upper end of the body, the mouthpiece providing a fluid passage from the replaceable heater; and
a cavity configured to store a product for vaporizing.

9. The cartridge of claim 8, further comprising an inner column, and wherein:
the inner column comprises an inner liner and an outer liner surrounding the inner liner;
the fluid path is formed between the inner liner and the outer liner; and
the fluid passage is defined within the inner liner.

10. The cartridge of claim 9, wherein:
the cartridge further comprises an outer wall surrounding the inner column; and
the cavity is formed between the outer wall and the inner column.

11. The cartridge of claim 10, wherein the replaceable heater defines at least one port in fluid communication with the cavity.

12. The cartridge of claim 9, wherein the replaceable heater comprises:
a first recess configured to releasably receive the outer liner and seal the replaceable heater to the outer liner; and
a second recess configured to releasably receive the inner liner and seal the replaceable heater to the inner liner.

13. The cartridge of claim 9, wherein the replaceable heater comprises a protrusion configured to releasably mate with the inner liner.

14. The cartridge of claim 8, further comprising an airflow ring configured to rotate about the fluid intake to adjust restriction of fluid flow into the fluid intake.

15. The cartridge of claim 14, wherein:
the airflow ring comprises a slot;
when the airflow ring is rotated about the fluid intake such that the slot aligns with the fluid intake, restriction of airflow into the fluid intake is at a minimum; and
when the airflow ring is rotated about the fluid intake such that no portion of the slot aligns with the fluid intake, airflow into the fluid intake is completely obstructed.

16. A battery case for a vaporizer, comprising:
a body;
a battery disposed within the body;
circuitry disposed within the body and configured to operate the vaporizer;
at least one light source within the body; and
at least one pattern of holes positioned over the at least one light source, wherein the holes have a diameter less than fifty micrometers.

17. The battery case of claim 16, wherein the at least one light source, when illuminated, shines through the at least one pattern of holes and illuminates the at least one pattern of holes in a manner visible from outside the body.

18. The battery case of claim 16, wherein the at least one pattern of holes is formed in a surface of the body.

19. The battery case of claim 18, wherein the surface of the body is an inner surface of the body.

20. The battery case of claim 18, wherein the at least one pattern of holes is formed by micro drilling the surface of the body.
